(19) United States
(12) Patent Application Publication
(10) Pub. No.: US 2024/0075355 A1
(43) Pub. Date: Mar. 7, 2024

(54) IRON GOLF CLUB HEAD

(71) Applicant: Sumitomo Rubber Industries, Ltd., Kobe-shi (JP)

(72) Inventor: Kiyofumi MATSUNAGA, Kobe-shi (JP)

(73) Assignee: Sumitomo Rubber Industries, Ltd., Kobe-shi (JP)

(21) Appl. No.: 18/235,197

(22) Filed: Aug. 17, 2023

(30) Foreign Application Priority Data
Sep. 1, 2022 (JP) 2022-139423

(51) Int. Cl. A63B 53/04

(52) U.S. Cl. CPC A63B 53/047; A63B 53/0433; A63B 2053/0491

(57) ABSTRACT

An iron golf club head includes a head body having a sole portion, a weight member disposed in the sole portion, and a fixing member for fixing the weight member to the head body. The head body is provided with a first hole and a second hole. The first hole opens at a bottom surface of the sole portion. The weight member is in the first hole by insertion from below the head in a first direction. The second hole opens at a surface of the head body. The fixing member is inserted into the weight member from the second hole in a second direction different from the first direction.

### RELATED APPLICATIONS

This application claims the benefit of foreign priority to Japanese Patent Application No. JP2022-139423, filed Sep. 1, 2022, which is incorporated by reference in its entirety.

### FIELD OF THE DISCLOSURE

The present disclosure relates to an iron golf club head.

### BACKGROUND OF THE DISCLOSURE

Iron golf club heads that can increase the distance of a hit ball are desired. In general, long distance of a hit ball is achieved when the ball is struck at the sweet spot of the club face. The sweet spot is the point where the normal line from the center of gravity of the head to the club face of the face portion intersects the club face.

Iron golf club heads often strike golf balls placed directly on the turf. As a result, the iron golf club heads often strike the ball at a position approximately 15 mm above the bottom edge of the club face. In order to increase the flight distance of iron golf club heads, it is important to design the center of gravity of the head to be lower by placing a weight member with a higher specific gravity in the sole portion of the head body (see Patent document 1 below).

### PATENT DOCUMENT

### [Patent Document 1]

Japanese Unexamined Patent Application Publication 2016-221181

### SUMMARY OF THE DISCLOSURE

Unfortunately, it is difficult to weld the weight member to the head body with sufficient joint strength because the chemical composition of the weight member is different from that of the head body.

Alternatively, it could be assumed that the weight member is attached to the head body by means of a screw inserted from the bottom of the head. However, in this case, the insertion direction of the screw coincides with the direction of the action of centrifugal force during swinging, and the screw is likely to loosen with repeated swings, and thus the weight member may easily fall off from the head body.

The present disclosure has been made in view of the above problem and has a main object to provide an iron golf club head to which a weight member can be firmly fixed to the head body by a method other than welding.

In one aspect of the present disclosure, an iron golf club head includes a head body having a sole portion, a weight member disposed in the sole portion, and a fixing member for fixing the weight member to the head body, wherein the head body is provided with a first hole and a second hole, the first hole opens at a bottom surface of the sole portion, the weight member is in the first hole by insertion from below the head in a first direction, the second hole opens at a surface of the head body, and the fixing member is inserted into the weight member from the second hole in a second direction different from the first direction.

### BRIEF DESCRIPTION OF THE DRAWINGS

FIG. 1 is a front view of an exemplary iron golf club head in accordance with the present embodiment;

FIG. 2 is a rear view of the iron golf club head in accordance with the present embodiment;

FIG. 3 is a bottom view of the iron golf club head in accordance with the present embodiment:

FIG. 4 is a perspective view of the iron golf club head in accordance with the present embodiment as seen from below and from the rear;

FIG. 5 is a perspective view of the iron golf club head in accordance with the present embodiment as seen from above and from the rear;

FIG. 6 is an exploded perspective view of the iron golf club head in accordance with the present embodiment;

FIG. 7 is an enlarged cross-sectional view taken along lines VII-VII of FIG. 2;

FIG. 8 is a cross-sectional view taken along lines VIII-VIII of FIG. 2;

FIG. 9 is a cross-sectional view taken along line IX-IX of FIG. 2;

FIG. 10 is a perspective view of a weight member in accordance with the present embodiment;

FIG. 11 is a bottom view of the iron golf club head in accordance with another embodiment:

FIG. 12 is an exploded perspective view of the iron golf club head of FIG. 11;

FIG. 13 is a perspective view illustrating the reference state of an iron golf club head:

FIG. 14 is a rear view of the iron golf club head in accordance with another embodiment; and

FIG. 15 is a cross-sectional view taken along lines XV-XV of FIG. 14.

### DETAILED DESCRIPTION OF THE DISCLOSURE

Hereinafter, one or more embodiments of the present disclosure will be described based on the drawings.

The embodiments described herein are not intended to limit the present disclosure in any way. In addition, the features described as modifications in the embodiments may be used alone or in combination with other various features. Further, it should be noted that the common or same elements throughout the embodiments are given the same reference numerals and redundant explanations are omitted.

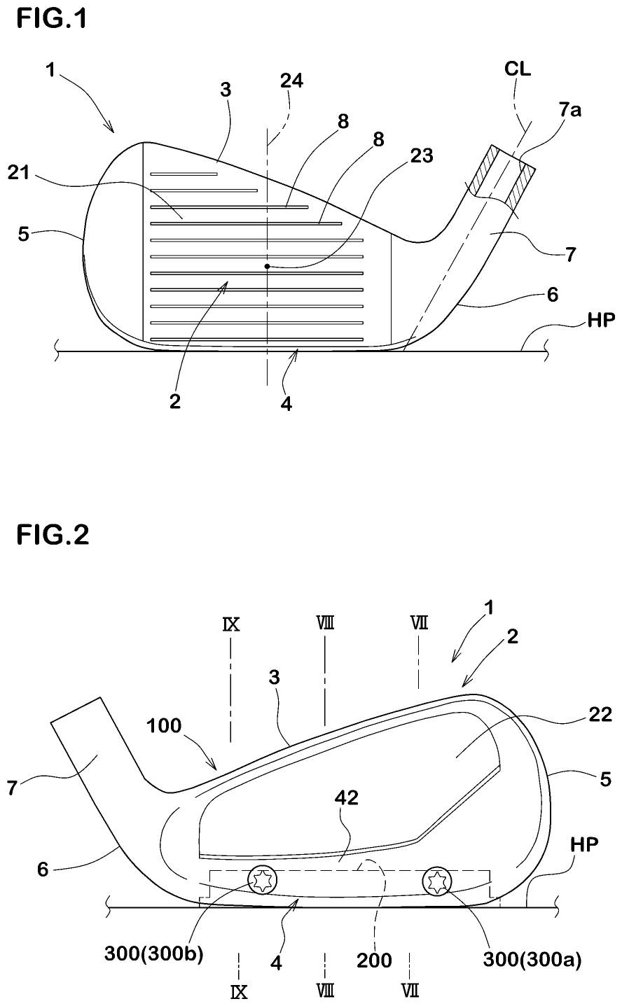

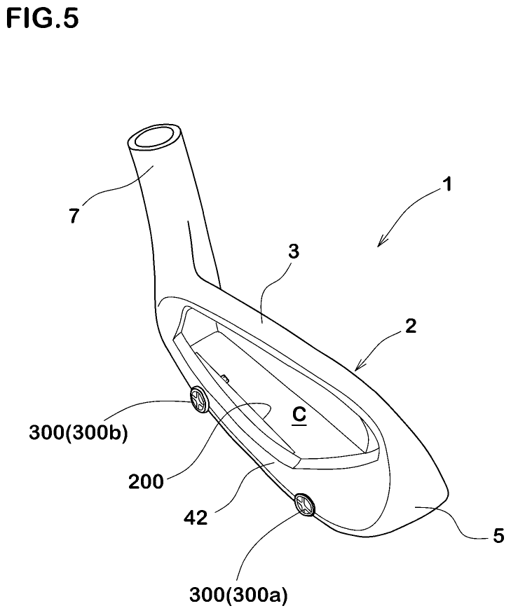

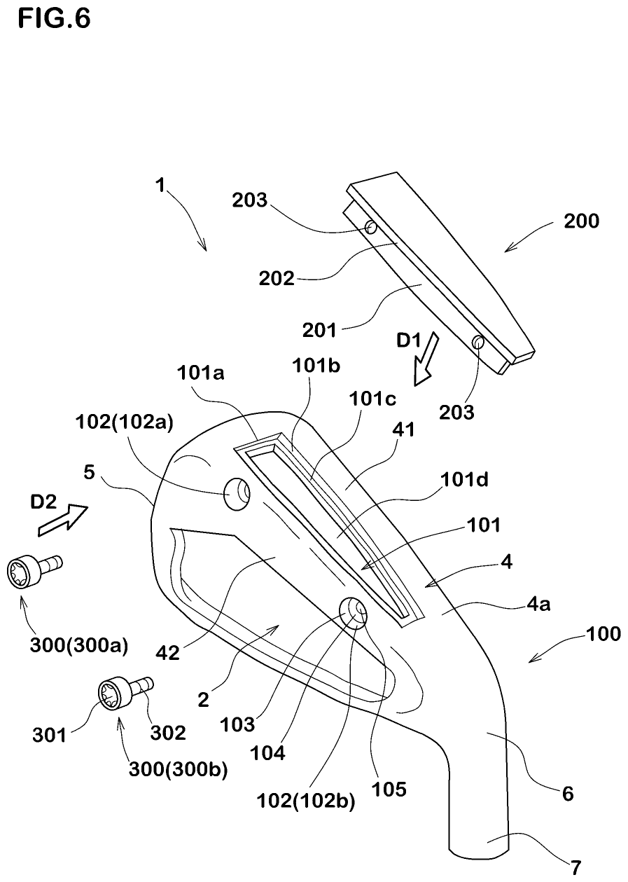

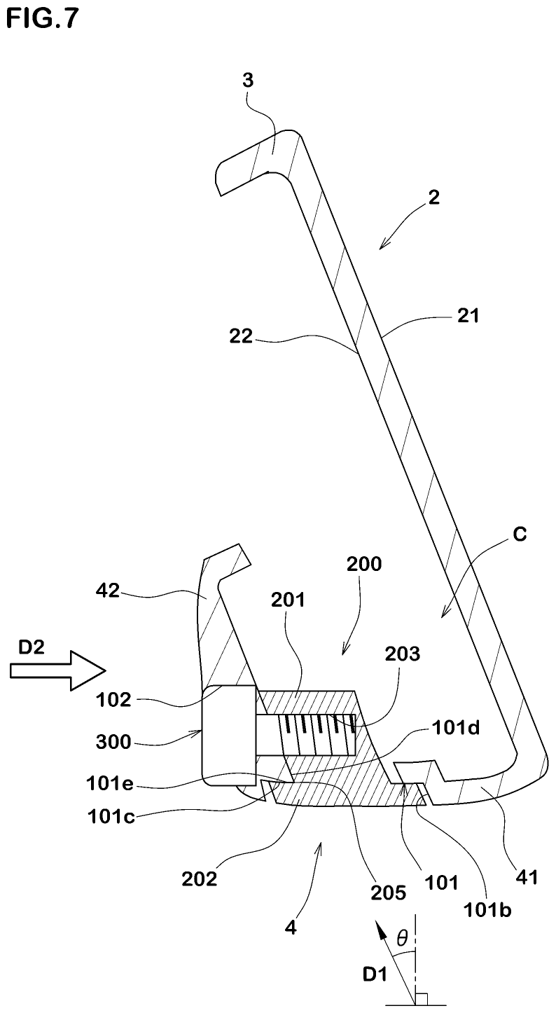

FIGS. 1 to 3 are front, rear and bottom views, respectively, of an iron golf club head (hereinafter simply referred to as “head”) 1 of the present embodiment. FIGS. 4 and 5 are rear perspective views of the head 1, and FIG. 6 is an exploded perspective view of the head 1. FIGS. 7 and 9 are cross-sectional views of FIG. 2 taken along the lines VII-VII, VIII-VIII, and IX-IX, respectively.

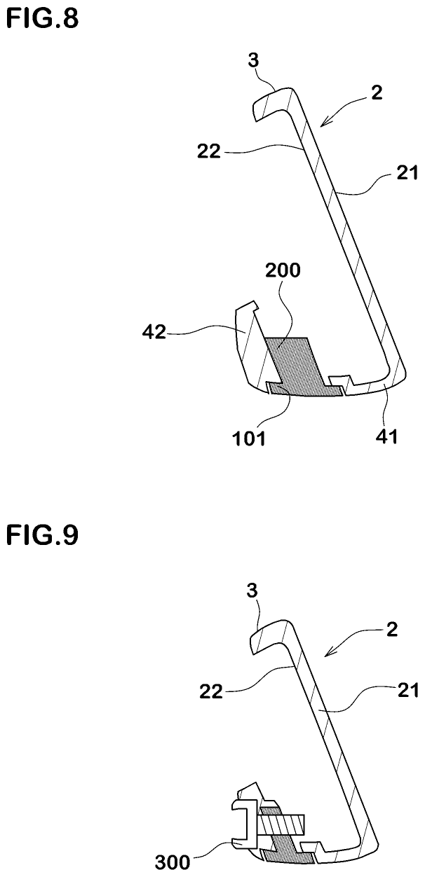

As illustrated in FIGS. 1 to 9, the head 1, for example, includes a face portion 2, a top portion 3, a sole portion 4, a toe 5, a heel 6, and a hosel 7. In the present embodiment, the head 1, for example, is entirely made of metal material. Alternatively, the head 1, for example, may be partially made of non-metallic materials such as fiber-reinforced plastics.

The face portion 2 includes a striking face 21 which is the surface for striking the ball. The face 21 is the primary surface of the head 1 for striking the ball. As illustrated in FIG. 1, a plurality of face lines 8 are formed on the striking face 21. The face lines 8 are narrow grooves extending in a straight manner in the toe-heel direction. The face lines 8 help to increase friction with the ball. Note that the face lines 8 are omitted except in FIG. 1.

### [Reference State]

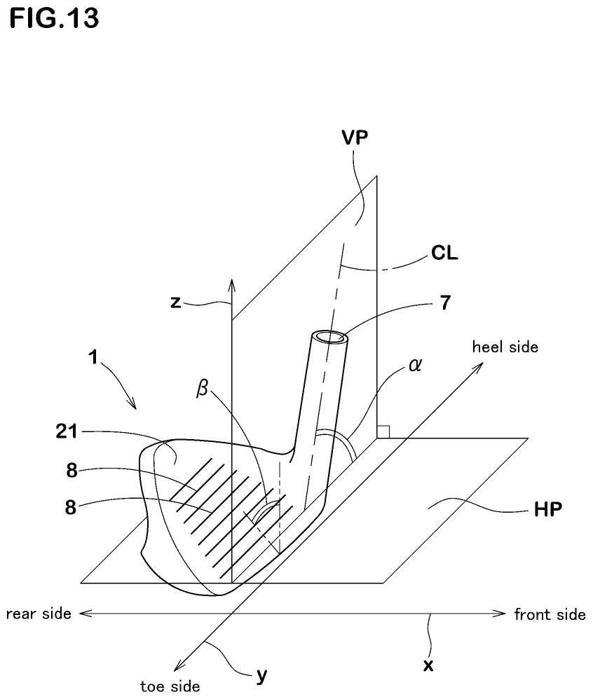

In FIGS. 1 to 3, the head 1 is in a reference state. As used herein, the “reference state” of the head 1 means a state in which the head 1 is placed on the horizontal plane HP such that the face lines 8 formed on the striking face 21 are parallel to the horizontal plane HP, as shown conceptually in FIG. 13. In the reference state, the center axis CL of the hosel 7 of the head 1 (the axis of the club shaft) is located within the reference vertical plane VP. The reference vertical plane VP is a plane perpendicular to the horizontal plane HP. In the reference state, the face lines 8 are parallel to both the horizontal plane HP and the reference vertical plane VP. Throughout this specification and claims, unless otherwise noted, the configuration of each portion is explained assuming that the head 1 is placed in the reference state. In FIG. 13, “α” and “β” denote the lie angle and the loft angle, respectively. The lie angle α is the angle between the horizontal plane HP and the center axis CL of the hosel 7. The loft angle β is the angle between the reference vertical plane VP and the striking face 21. These lie angle α and loft angle β are predetermined in the head 1 and are usually listed in the product catalogs.

### [Club Head Directions]

Referring to FIG. 13, the front or front side of the head 1 means the side of the striking face 21. The rear or rear side of the head 1 means the side opposite to the striking face 21 (rear face 22). The head front-back direction is the direction of the x-axis orthogonal to the reference vertical plane VP in FIG. 13. The toe-heel direction of the head 1 is the direction of the horizontal y-axis orthogonal to the front-back direction of the head. The vertical direction of the head 1 is the direction of the z-axis orthogonal to both the x-axis and the y-axis. The “top” and “bottom” of the head 1 are the “top” and “bottom” in the reference state, respectively.

### [Structure of Each Part of Head].

Referring to FIGS. 1, 2 and 7 to 9, the face portion 2 includes the striking face 21 and the rear face 22 that is opposite surface to the striking face. In the present embodiment, the striking face 21 is formed by a single plane, with the exception of the face lines 8.

As illustrated in FIG. 1, the face portion 2 further includes a face center 23 and a virtual vertical plane 24.

The face center 23 is a point on the striking face 21, being an intermediate position in the toe-heel direction between the most toe-side edge and the most heel-side edge of the face lines 8. The face center 23 is also, at the intermediate position on the striking face 21, the intermediate position in the direction along the striking face 21 between the top-side edge and the sole-side edge. The face center 23 is one of the ideal striking positions for many golfers.

The virtual vertical plane 24 is a virtual vertical plane passing through the face center 23 and orthogonal to the striking face 21.

The top 3, for example, extends from the upper edge of the striking face 21 to the rear of the head 1 and forms the top part of the head 1.

The toe 5 is the end portion of the head 1 farthest from the hosel 7 in the toe-heel direction and smoothly connects the top 3 with the sole portion 4.

The heel 6 is the end portion of the head 1 opposite the toe 5 in the toe-heel direction. The hosel 7 extends upwards from the heel 6.

As illustrated in FIG. 1, the hosel 7 is provided with a shaft insertion hole 7a for receiving a golf club shaft (not shown). The central axis CL of the hosel 7 is defined by the central axis of the shaft insertion hole 7a.

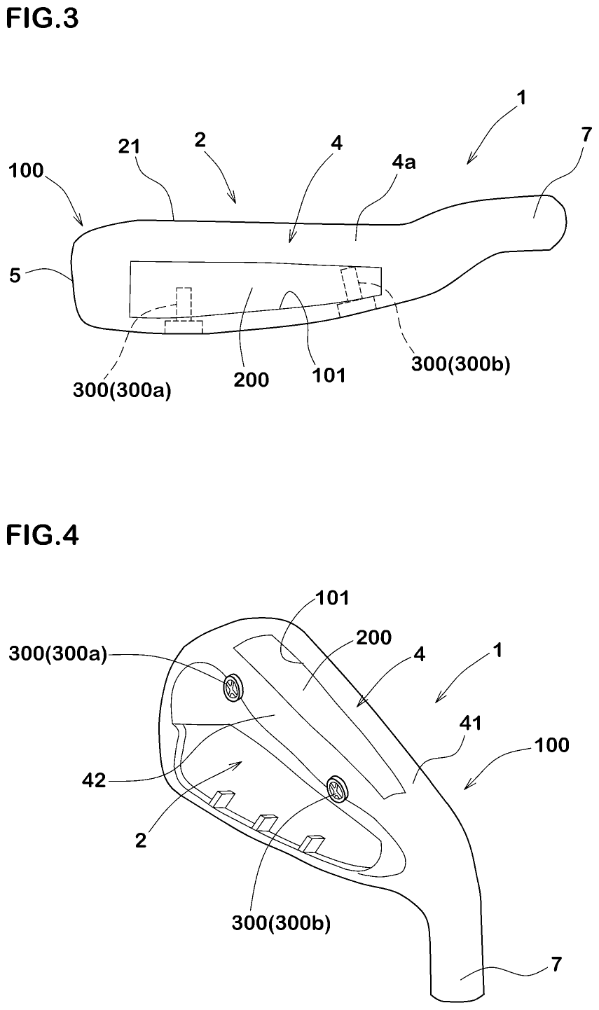

FIG. 3 is a bottom view of the head 1 viewed from a direction along the striking face 21. As illustrated in FIG. 3, the sole portion 4 extends from, for example, the face portion 2 to the rear of the head. The sole portion 4 comprises a bottom surface 4a. This bottom surface 4a is the portion visible in the bottom view of the head 1.

As well shown in FIG. 7, the sole portion 4 of the present embodiment includes a first portion 41 located on the face portion 2 side and a second portion 42 extending upward of the head on a rear side of the first portion 41. The second portion 42 is spaced apart from the rear surface 22 of the face portion 2. Thus, between the second portion 42 and the rear surface 22 of the face portion 2, a cavity C is formed which extends towards the bottom side of the head. The cavity C of the present embodiment is a so-called undercut cavity.

FIG. 6 is an exploded perspective view of the head 1. As illustrated in FIG. 6, the head 1 in accordance with the present embodiment includes a head body 100, a weight member 200, and a fixing member 300 for fixing the weight member 200 to the head body 100.

### [Head Body]

The head body 100 includes the sole portion 4. In the present embodiment, the head body 100 further includes the face portion 2 and the hosel 7. That is, the head body 100 according to the present embodiment is a portion of the head 1 without the weight member 200 and the fixing member 300.

For example, the head body 100 comprises a metallic material having a first specific gravity. For the metallic material, e.g., titanium, titanium alloys, stainless steel, maraging steel, carbon steel, and the like can be employed. In other examples, the head body 100 may comprise several metallic materials with different specific gravities. In this case, the specific gravity (first specific gravity) of the head body 100 shall be defined as the average of the specific gravities of the materials weight membered by their volume.

The head body 100 is provided with a first hole 101 and a second hole 102.

### [First Hole]

The first hole 101 is a recess or hole for placing the weight member 200. In this embodiment, there is a single first hole 101. The first hole 101 opens at the bottom surface 4a of the sole portion 4. The first hole 101 includes an opening edge 101a extending on the bottom surface 4a, a side surface 101b extending from the opening edge 101a inwardly into the head, a recessed bottom 101c, and a main hole 101d.

For example, the opening edge 101a of the first hole 101 has a closed contour shape extending longitudinally in the toe-heel direction. More specifically, the opening edge 101a extends across the virtual vertical plane 24. Note that the opening edge 101a in the present embodiment has, for example, a rectangular contour shape, but is not limited to such a shape.

The side surface 101b of the first hole 101 defines a hole inner surface extending inwardly from the opening edge 101a into the head. In the present embodiment, as illustrated in FIG. 7, the side surface 101b extends from the opening edge 101a along the first direction D1. For example, the first direction D1 is essentially the direction from the bottom of the head to the top of the head. More specifically, in the present embodiment, the first direction D1 is not completely vertical, but is inclined at an angle θ with respect to the vertical direction. The direction of inclination is, for example, behind the head, but may be other than this. In this case, the angle θ is smaller than 45 degrees. Therefore, the first direction D1 in the present embodiment is the direction from the bottom to the top of the head, because the vertical component is more dominant than the horizontal component.

The recessed bottom 101c of the first hole 101 is recessed from the bottom surface 4a of the sole portion 4. For example, the recessed bottom 101c includes a surface along the bottom surface 4a, e.g., a shelf-like extension from the side surface 101b.

The main hole 101d is provided on the recessed bottom 101c of the first hole 101. The main hole 101d has a smaller contour shape than the contour shape of the opening edge 101a. In the present embodiment, the main hole 101d has a closed contour shape extending longitudinally in the toe-heel direction. More specifically, the main hole 101d also extends across the virtual vertical plane 24. For example, the main hole 101d has a rectangular contour shape, but is not limited to such a shape. In addition, in the present embodiment, the main hole 101d is formed as a through hole passing through the first portion 41. In another aspect, the main hole 101d may be a recess with a bottom.

### [Second Hole]

The second hole 102 is a space for placing the fixing member 300. For example, a plurality of second holes 102 are provided in the head body 100. In the present embodiment, the second holes 102 include a toe-side second hole 102a located on the toe 5 side from the virtual vertical plane 24 and a heel-side second hole 102b located on the heel 6 side from the virtual vertical plane 24.

Each of the second holes 102 opens on the surface of the head body 100. In the present embodiment, each of the second holes 102 opens on the surface of the sole portion 4 of the head body 100. More specifically, the second holes 102 are formed on the second portion 42 of the sole portion 4. The second holes 102 have a cylindrical space having an axial centerline in the second direction D2. More specifically, the second holes 102 include a large-diameter portion 103 on the rear side of the head and a small-diameter portion 105 connected thereto via a stepped portion 104. In the present embodiment, each second hole 102 is formed as a through hole passing through the second portion 42.

### [Weight Member]

The weight member 200 is placed in the sole portion 4 of the head body 100. More precisely, the weight member 200 is placed in the first hole 101 provided in the sole portion 4. The weight member 200 is composed of a metallic material having a second specific gravity. The second specific gravity is greater than the first specific gravity of the head body 100. Therefore, the weight member 200 can help to adjust the head center of gravity to a lower position.

The second specific gravity is not limited as long as it is greater than the first specific gravity, but is preferably equal to or more than 9.0, more preferably equal to or more than 10.0, and even more preferably equal to or more than 12.0. For the weight member 200, stainless steel, alloys containing W, and the like are suitable as metal materials. In particular, alloys containing W and Ni are suitable in order to increase the second specific gravity. Although weldability of such alloys to the head body 100 is significantly deteriorated, the weight member 200 of the present embodiment can be firmly fixed to the head body 100 without welding, thus maximizing the specific gravity.

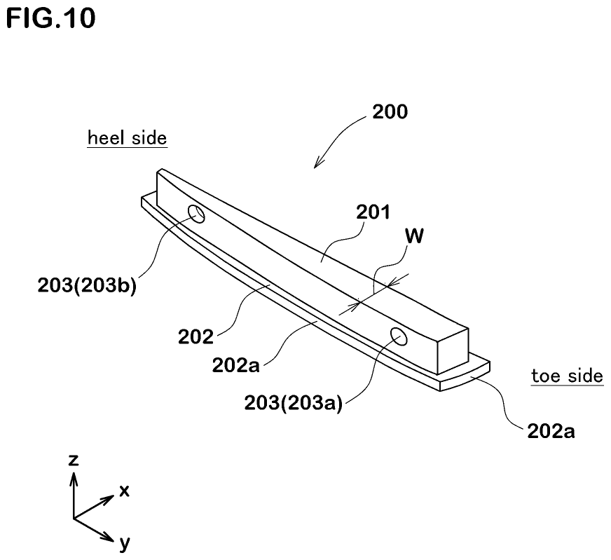

FIG. 10 shows an enlarged perspective view of the weight member 200 of this embodiment. As shown in FIG. 6 and FIG. 10, the weight member 200 includes a main portion 201 and a flange portion 202 protruding from at least a part of a circumference of the main portion 201.

The main portion 201 extends long along the toe-heel direction (y). In the present embodiment, the main portion 201 extends across the virtual vertical plane 24. The cross section of the main portion 201 at the virtual vertical plane 24 is, for example, rectangular. The main portion 201 has a width W in the head front-back direction. By adjusting the width W, the position of the center of gravity of the head in the toe-heel directions can be adjusted. In the present embodiment, the width W of the main portion 201 is, for example, continuously increasing toward the toe 5 in order to balance the weight member of the hosel 7. In other examples, the width W of the main portion 201 may increase toward the heel 6.

The main portion 201 is provided with at least one fixing hole 203. In the present embodiment, a plurality of fixing holes 203 are provided. The fixing holes 203 include, for example, a toe-side fixing hole 203a located on the toe 5 side with respect to the virtual vertical plane 24 and a heel-side fixing hole 203b located on the heel 6 side with respect to the virtual vertical plane 24. In the present embodiment, each fixing hole 203 is configured as a threaded hole with a female thread.

For example, the flange portion 202 is provided all around the main portion 201. In other words, the flange portion 202 continuously protrudes from the main portion 201 at the front, the rear, the toe and the heel sides. In other cases, the flange portion 202 may be provided only at the front and the rear of the main portion 201. Also, as shown in FIG. 7 or 9, the flange portion 202 has a side surface 202a that conforms to the side surface 101b of the first hole 101.

As illustrated in FIGS. 6 and 7, the weight member 200 is inserted into the first hole 101 in the first direction D1 from below the head. More specifically, the weight member 200 of the present embodiment is inserted into the first hole 101 with the main portion 201 facing up, aligned with the opening edge 101a of the first hole 101, and moved in the first direction D1. The weight member 200 can be then temporarily attached to the first hole 101, as shown in FIGS. 7 to 9. In this case, the center of the fixing hole 203 of the weight member 200 is designed so that the center of its axis is nearly aligned with the center of the axis of the second hole 102.

In this mounted state, the main portion 201 of the weight member 200 passes through the main hole 101d of the first hole 101 and protrudes toward the cavity C side. Also, the flange portion 202 of the weight member 200 comes into contact with the recessed bottom 101c of the first hole 101, which restricts upward movement thereafter. Furthermore, the side surface 202a of the flange portion 202 is arranged to face the side surface 101b of the first hole 101. As is clear from FIG. 6, the weight member 200 is exposed to the outside of the head at the sole portion 4 and constitutes a part of the bottom surface 4a. As a preferred embodiment, the flange portion 202 forms a surface that is continuous with the bottom surface of the sole portion 4 of the head body 100 when fixed to the first hole 101.

### [Fixing Member]

The fixing member 300 is used to fix the weight member 200 attached to the first hole 101 to the head body 100. The fixing member 300 of the present embodiment includes a plurality of fixing members 300 which includes a toe-side fixing member 300a and a heel-side fixing member 300b corresponding to the second holes 102.

Each of the fixing members 300 of the present embodiment is formed as a screw member, for example. More precisely, each fixing member 300 includes a head portion 301 and a shaft portion 302.

Each head portion 301 has a groove or recess into which various wrenches can be inserted to rotate the fixing member 300 around its axis. Each head portion 301 is cylindrical in shape, slightly smaller than the inner diameter of the large-diameter portions 103 of the second holes 102 and larger than the inner diameter of the small-diameter portions 105.

Each shaft portion 302 is formed as a male thread. This male thread can engage the female thread of the fixing holes 203 formed in the weight member 200. The maximum outer diameter of the shaft portion 302 is slightly smaller than the inner diameter of the small-diameter portions 105 of the second holes 102.

Also, the fixing members 300 of the present embodiment are inserted into the weight member 200 in the second direction D2, which is different from the first direction D1, through the second holes 102. As shown in FIGS. 6 and 7, the second direction D2 in this embodiment is the direction toward the front of the head.

### [Fixing Weight Member]

Next, the method of fixing the weight member 200 to the head body 100 using the fixing members 300 is described. First, the weight member 200 is inserted into the first hole 101 in the first direction D1 as described above. Then, the weight member 200 is temporarily attached to the first hole 101.

Next, the fixing members 300 are inserted into the second holes 102. The shaft portions 302 of the fixing members 3M) pass through the small-diameter portions 105 of the second holes 102 and face the fixing holes 203 of the weight member 200, which is temporarily attached to the first hole 101.

The fixing members 300 are then tightened using a tool such as a wrench. The fixing members 300 are then inserted into the weight member in the second direction D2, which is different from the first direction D1. That is, the shaft portions 302 of the fixing members 300 enter the fixing holes 203 of the weight member 200 while being screwed in. By further screwing in after the head portions 301 of the fixing members 300 contact the steps 104 of the second holes 102, the weight member 200 is pulled into the second portion 42 and firmly fixed to the head body 100. A washer (not illustrated) can be added between the head portions 301 of the fixing members 300 and the steps 104 of the second holes 102. This can further secure the weight member 200 to the head body 100.

By adopting the above configuration, the head 1 according to the present embodiment can place the weight member 200 on the sole portion 4 by a method other than welding. Therefore, the head 1 according to the present embodiment can be equipped with the head center of gravity at a lower position, which helps to increase the distance of the hit ball. In some preferred embodiments, the sweet spot height of the head 1 from the horizontal plane HP is preferably equal to or less than 22 mm, more preferably equal to or less than 21 mm, and even more preferably equal to or less than 20 mm, by making the weight member 200 higher in specific gravity and/or larger in size.

In the head 1 according to the present embodiment, the direction of insertion of the weight member 200 into the first hole 101 (the first direction D1) and the direction of insertion of the fixing members 300 into the weight member 200 (the second direction D2) are different. Therefore, the fixing members 300 effectively prevents the weight member 200 from leaving the first hole 101 (movement in the direction opposite to the first direction D1). Also, the weight member 200 can be firmly fixed to the head body 100. In addition, since the second direction D2 in the present embodiment does not coincide with the direction of action of the centrifugal force during swinging, the fixing members 300 are difficult to loosen during swinging, and thus the release of the weight member 200 from the head body 100 can be prevented for a long period of time.

Furthermore, in the present embodiment, as shown in FIG. 7, the main portion 201 of the weight member 200 is inclined toward the rear of the head toward the top of the head. Thus, an internal acute corner 205 is formed between the main portion 201 and the flange portion 202 extending toward the rear of the head. This corner 205, when the fixing members 300 are tightened, strongly mates with the external acute corner 101e between the recessed bottom 101c on the rear side of the head and the main hole 101d of the first hole 101, and the position of the weight member 200 is stabilized. Therefore, it is desirable to prevent the weight member 200 from rattling.

If the weight member 200 is not intended to be replaced, the head 1 may be filled with adhesive or the like between the fixing members 300 and the weight member 200, and/or between the fixing members 300 and the head body 100 to further increase the strength of the bond between these. On the other hand, the weight member 200 may be interchangeable. For example, the weight member 200 may be prepared in advance in several different shapes and/or weight members. In this case, the fixing members 300 are detachably attached to the weight member 200 using a tool such as a wrench. Then, according to various needs, one of the weight members 200 selected by a user or manufacturer from the plurality of the weight members 200 can be attached to the head body 100. Furthermore, the weight member 200 already attached can be exchanged for another weight member 200.

The specific gravity of the fixing members 300 (hereinafter referred to as the third specific gravity) is not particularly limited, but in order to design the head center of gravity lower, the third specific gravity is preferably equal to or more than the first specific gravity.

### Another Embodiment

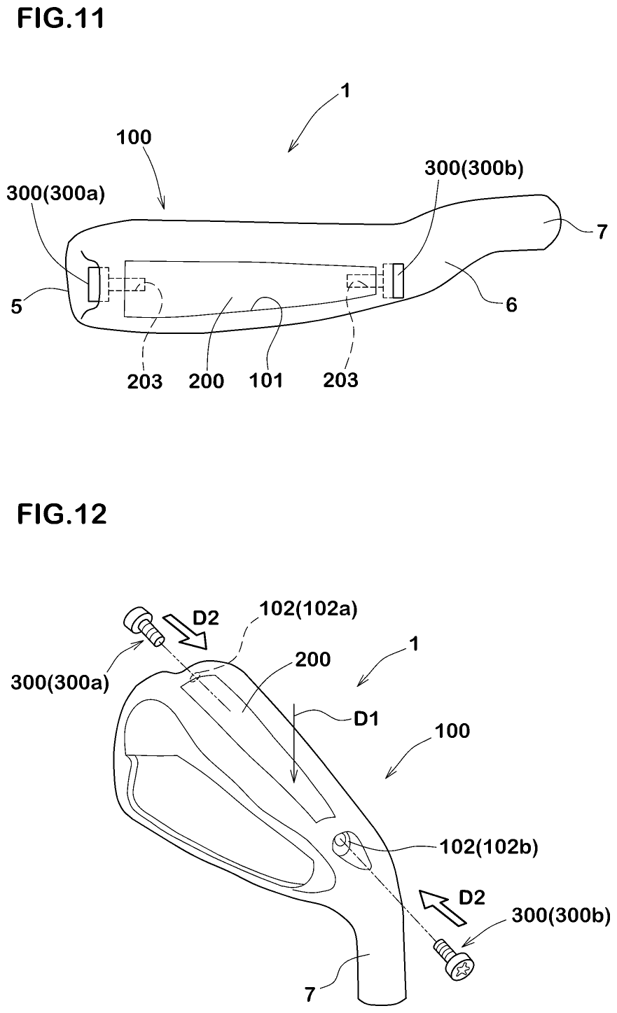

FIG. 11 is a bottom view of the head 1 in accordance with another embodiment, FIG. 12 is an exploded perspective view of the head 1. In this embodiment, as shown in FIG. 11 and FIG. 12, the first direction D1 is the direction toward the top of the head as in the previous embodiment. On the other hand, in this embodiment, the second direction D2 is toward the toe and/or the heel. That is, in this embodiment, the second holes 102 are provided on the end faces of the toe 5 side and the heel 6 side of the head body 100. In addition, the toe side second hole 102a and the heel side second hole 102b extending along the second direction D2 are formed on the toe side end face and the heel side end face of the weight member 200, respectively. In such an embodiment, the same action as in the previous embodiment can be achieved.

In particular, in this embodiment, the weight member of the fixing member 300a on the toe side and the fixing member 300b on the heel side is distributed more to the toe side and the heel side, respectively, than in the previous embodiment. Therefore, in this embodiment, the moment of inertia around the vertical axis passing through the center of gravity of the head can be larger, which is expected to have the effect of improving the directionality of the hit ball at the time of miss shots.

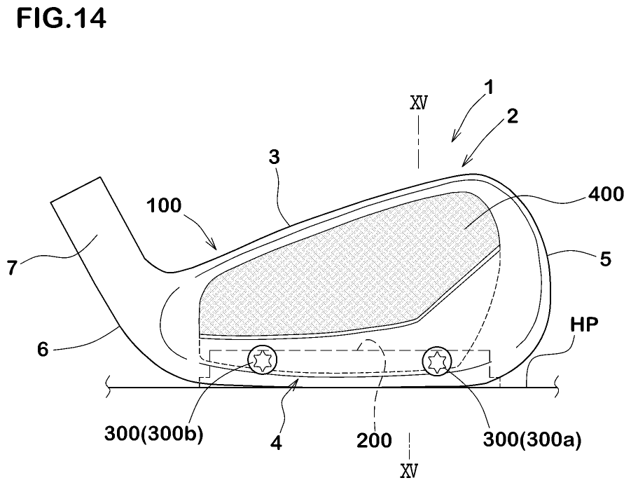

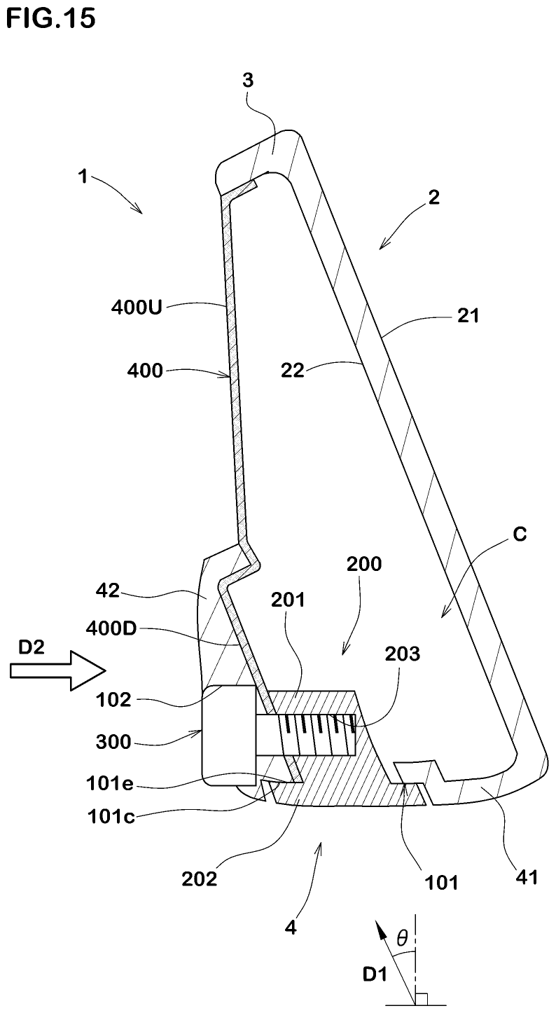

FIG. 14 is a rear view of the head 1 according to another embodiment, and FIG. 15 is a cross-sectional view taken along lines XV-XV of FIG. 14. As illustrated in FIGS. 14 and 15, the head 1000 may include a badge 400. The badge 400 can be made of apiece of plastic, metal or a complex thereof. The head 1 has a recessed cavity C in the rear surface, and the badge 400 is arranged to cover at least a portion of the cavity C from the rear. In this embodiment, the badge 400 completely covers the cavity C of the head such that the cavity C is not exposed to the exterior of the head. The badge 400 includes an upper portion 400U that is exposed to the exterior of the head and a lower portion 400D that extends from the top of the second portion 42 to the sole portion along an inner surface of the second portion 42. Thus, the lower portion 400D is not exposed to the exterior of the head 1000. In addition, at least a part of the badge 400 is sandwiched between the head body 100 and the weight member 200. In this embodiment, a part of the lower portion 400D is located in a gap between the head body 100 (the second portion 42) and the weight member 200 and is co-tightened using fixing members 300.

Although the embodiments of the present disclosure have been described above, the present disclosure is not limited to the above embodiments and can be modified into various forms. For example, in the above embodiment, the fixing members 300 are illustrated as screws, but are not limited to those. For example, at least one fixing member 300 can be a key or other mechanical element that can be caulked or press-fitted into the fixing hole 203 of the weight member 200. In addition, the present disclosure includes equivalents.

### [Additional Note]

The present disclosure includes the following aspects.

### [Note 1]

An iron golf club head comprising:
a head body having a sole portion;
a weight member disposed in the sole portion; and
a fixing member for fixing the weight member to the head body,
wherein
the head body is provided with a first hole and a second hole,
the first hole opens at a bottom surface of the sole portion,
the weight member is in the first hole by insertion from below the head in a first direction,
the second hole opens at a surface of the head body, and
the fixing member is inserted into the weight member from the second hole in a second
direction different from the first direction.

### [Note 2]

The iron golf club head according to note 1, wherein
the fixing member comprises a male thread, and
the weight member comprises a female thread that engages with the male thread.

### [Note 3]

The iron golf club head according to note 1 or 2, wherein
the head body has a first specific gravity, and
the weight member has a second specific gravity greater than the first specific gravity.

### [Note 4]

The iron golf club head according to any one of notes 1 to 3, wherein
the first direction is a direction upward of the head, and
the second direction is a direction toward the front of the head.

### [Note 5]

The iron golf club head according to any one of notes 1 to 4, wherein
the sole portion comprises a first portion extending in a head front-back direction and a second portion extending upward of the head on a rear side of the first portion,
the first hole is formed in the first portion, and
the second hole is formed in the second portion.

### [Note 6]

The iron golf club head according to any one of notes 1 to 5, wherein
the weight member extends in a toe-heel direction, and
the fixing member comprises a toe-side fixing member for fixing a toe side of the weight member and a heel-side fixing member for fixing a heel side of the weight member.

### [Note 7]

The iron golf club head according to any one of notes 1 to 6, wherein
the weight member comprises a main portion and a flange portion protruding from at least a part of a circumference of the main portion, and
the first hole comprises
   a recess that is recessed from the bottom surface of the sole portion and comprises a recessed bottom that is in contact with the flange portion, and
   a hole formed in the recessed bottom to receive the main portion.

### [Note 8]

The iron golf club head according to any one of notes 1 to 7, wherein
the first direction is a direction upward of the head, and
the second direction is a direction toward a toe and/or a heel of the head.

### [Note 9]

The iron golf club head according to any one of notes 1 to 8, further comprising a badge, wherein
at least a part of the badge is sandwiched between the head body and the weight member.

### [Note 10]

An iron golf club head comprising:
a head body having a sole portion;
a weight member disposed in the sole portion; and
a fixing member for fixing the weight member to the head body,
wherein
the head body is provided with a first hole and a second hole.
the first hole opens at a periphery surface of the head body,
the weight member is in the first hole by insertion from a periphery side of the head in a first direction,
the second hole opens at a surface of the head body, and
the fixing member is inserted into the weight member from the second hole in a second direction different from the first direction.

### [Note 11]

The iron golf club head according to note 10, wherein
the fixing member comprises a male thread, and
the weight member comprises a female thread that engages with the male thread.

### [Note 12]

The iron golf club head according to note 10 or 11, wherein
the head body has a first specific gravity, and
the weight member has a second specific gravity greater than the first specific gravity.

### [Note 13]

The iron golf club head according to any one of notes 10 to 12, wherein
the first direction is a direction upward of the head, and
the second direction is a direction toward the front of the head.

### [Note 14]

The iron golf club head according to any one of notes 10 to 13, wherein
the sole portion comprises a first portion extending in a head front-back direction and a second portion extending upward of the head on a rear side of the first portion,
the first hole is formed in the first portion, and
the second hole is formed in the second portion.

### [Note 15]

The iron golf club head according to any one of notes 10 to 14, wherein
the weight member extends in a toe-heel direction, and
the fixing member comprises a toe-side fixing member for fixing a toe side of the weight member and a heel-side fixing member for fixing a heel side of the weight member.

### [Note 16]

The iron golf club head according to any one of notes 10 to 15, wherein
the weight member comprises a main portion and a flange portion protruding from at least a part of a circumference of the main portion, and
the first hole comprises
   a recess that is recessed from a bottom surface of the sole portion and comprises a recessed bottom that is in contact with the flange portion, and
   a hole formed in the recessed bottom to receive the main portion.

### [Note 17]

The iron golf club head according to any one of notes 10 to 16, wherein
the first direction is a direction upward of the head, and
the second direction is a direction toward a toe and/or a heel of the head.

### [Note 18]

The iron golf club head according to any one of notes 10 to 17, further comprising a badge, wherein
at least a part of the badge is sandwiched between the head body and the weight member.

1. An iron golf club head comprising:
a head body having a sole portion;
a weight member disposed in the sole portion; and
a fixing member for fixing the weight member to the head body,
wherein
the head body is provided with a first hole and a second hole,
the first hole opens at a bottom surface of the sole portion,
the weight member is in the first hole by insertion from below the head in a first direction,
the second hole opens at a surface of the head body, and
the fixing member is inserted into the weight member from the second hole in a second direction different from the first direction.

2. The iron golf club head according to claim 1, wherein
the fixing member comprises a male thread, and
the weight member comprises a female thread that engages with the male thread.

3. The iron golf club head according to claim 1, wherein
the head body has a first specific gravity, and
the weight member has a second specific gravity greater than the first specific gravity.

4. The iron golf club head according to claim 1, wherein
the first direction is a direction upward of the head, and
the second direction is a direction toward the front of the head.

5. The iron golf club head according to claim 1, wherein
the sole portion comprises a first portion extending in a head front-back direction and a second portion extending upward of the head on a rear side of the first portion,
the first hole is formed in the first portion, and
the second hole is formed in the second portion.

6. The iron golf club head according to claim 1, wherein
the weight member extends in a toe-heel direction, and
the fixing member comprises a toe-side fixing member for fixing a toe side of the weight member and a heel-side fixing member for fixing a heel side of the weight member.

7. The iron golf club head according to claim 1, wherein
the weight member comprises a main portion and a flange portion protruding from at least a part of a circumference of the main portion, and
the first hole comprises
a recess that is recessed from the bottom surface of the sole portion and comprises a recessed bottom that is in contact with the flange portion, and
a hole formed in the recessed bottom to receive the main portion.

8. The iron golf club head according to claim 1, wherein
the first direction is a direction upward of the head, and
the second direction is a direction toward a toe and/or a heel of the head.

9. The iron golf club head according to claim 2, further comprising a badge, wherein
at least a part of the badge is sandwiched between the head body and the weight member.

10. An iron golf club head comprising:
a head body having a sole portion;
a weight member disposed in the sole portion; and
a fixing member for fixing the weight member to the head body,
wherein
the head body is provided with a first hole and a second hole,
the first hole opens at a periphery surface of the head body,
the weight member is in the first hole by insertion from a periphery side of the head in a first direction,
the second hole opens at a surface of the head body, and
the fixing member is inserted into the weight member from the second hole in a second direction different from the first direction.

11. The iron golf club head according to claim 10, wherein
the fixing member comprises a male thread, and
the weight member comprises a female thread that engages with the male thread.

12. The iron golf club head according to claim 10, wherein
the head body has a first specific gravity, and
the weight member has a second specific gravity greater than the first specific gravity.

13. The iron golf club head according to claim 10, wherein
the first direction is a direction upward of the head, and
the second direction is a direction toward the front of the head.

14. The iron golf club head according to claim 10, wherein
the sole portion comprises a first portion extending in a head front-back direction and a second portion extending upward of the head on a rear side of the first portion,
the first hole is formed in the first portion, and
the second hole is formed in the second portion.

15. The iron golf club head according to claim 10, wherein
the weight member extends in a toe-heel direction, and
the fixing member comprises a toe-side fixing member for fixing a toe side of the weight member and a heel-side fixing member for fixing a heel side of the weight member.

16. The iron golf club head according to claim 10, wherein
the weight member comprises a main portion and a flange portion protruding from at least a part of a circumference of the main portion, and
the first hole comprises
a recess that is recessed from a bottom surface of the sole portion and comprises a recessed bottom that is in contact with the flange portion, and
a hole formed in the recessed bottom to receive the main portion.

17. The iron golf club head according to claim 10, wherein
the first direction is a direction upward of the head, and
the second direction is a direction toward a toe and/or a heel of the head.

18. The iron golf club head according to claim 10, further comprising a badge, wherein
at least a part of the badge is sandwiched between the head body and the weight member.
